(19) United States
(12) Patent Application Publication
(10) Pub. No.: US 2011/0315609 A1
(43) Pub. Date: Dec. 29, 2011

(54) ULTRASONIC LINE SENSOR, AND SHEET HANDLING APPARATUS COMPRISING ULTRASONIC LINE SENSOR

(75) Inventors: Shota KURE, Kanagawa-ken (JP); Takahiro YAMAMOTO, Tokyo (JP); Junji MIURA, Kanagawa-ken (JP); Kazuhiro ITSUMI, Tokyo (JP); Takahisa NAKANO, Kanagawa-ken (JP); Yukio OONUKI, Tokyo (JP)

(73) Assignee: KABUSHIKI KAISHA TOSHIBA, Tokyo (JP)

(21) Appl. No.: 12/967,476

(22) Filed: Dec. 14, 2010

(30) Foreign Application Priority Data
Jun. 25, 2010 (JP) 2010-145521

(51) Int. Cl. B07C 5/34; H04R 17/00

(52) U.S. Cl. 209/590; 367/180

(57) ABSTRACT

According to one embodiment, an ultrasonic line sensor includes a plurality of ultrasonic sensors each comprising a circular vibrating surface and generating an electrical signal in accordance with an ultrasonic wave that enters the vibrating surface; and at least one sound absorbing member that is provided between the vibrating surfaces of the ultrasonic sensors and a detection target, and that absorbs an ultrasonic wave, the sound absorbing member being arranged in a position where the sound absorbing member overlaps both edge portions of the vibrating surfaces in a scanning direction that is perpendicular to a conveying direction of the detection target such that effective regions, which are regions in the vibrating surfaces not overlapped by the sound absorbing member, each have two sides parallel to the conveying direction of the detection target.

### CROSS-REFERENCE TO RELATED APPLICATION

This application is based upon and claims the benefit of priority from Japanese Patent Application No. 2010-145521, filed on Jun. 25, 2010, the entire contents of which are incorporated herein by reference.

### FIELD

Exemplary embodiments described herein relate to ultrasonic line sensors for detecting ultrasonic waves, and to sheet handling apparatuses comprising an ultrasonic line sensor.

### BACKGROUND

Conventionally, sheet handling apparatuses (banknote handling apparatuses) have been put into practice that count and discriminate various types of sheets such as banknotes. A sheet handling apparatus takes in sheets inserted into an insert port one by one, and conveys the sheets to an inspection device. The inspection device subjects the sheets to various sorts of processing and discriminates the state of the sheet. For example, the sheet handling apparatus may carry out a judgment on the type of the sheet, and a judgment on whether the banknote is genuine or false, based on the inspection result of the inspection device.

Moreover, the sheet handling apparatus may judge that for example a sheet to which foreign material, such as tape, is stuck is not fit for recirculation. The sheet handling apparatus judges that for example a sheet to which foreign material, such as tape, is stuck is not fit for recirculation. Furthermore, the sheet handling apparatus detects two or more stacked sheets (double-fed sheets). The sheet handling apparatus rejects the detected double-fed sheets.

For example, the inspection device may irradiate an ultrasonic wave onto the sheet, and detect the presence of foreign material, such as tape sticking to the sheet, by detecting a percolation wave or a reflected wave. Moreover, the inspection device irradiates an ultrasonic wave onto the sheets and detects percolation wave, thereby detecting stacked sheets.

A transmittance device including the ultrasonic sensor that is used in the inspection device described above receives input of signals through an piezoelectric element, and causes a vibrating surface provided in contact with the piezoelectric element to vibrate. In this manner, the transmittance device emits waves corresponding to the received signals into the air.

Also, a receiving device including the ultrasonic sensor that is used in the inspection device obtains as a detection signal an electrical signal generated by the piezoelectric element whose form changes in response to vibration of the vibrating surface provided in contact with the piezoelectric element.

The form of the ultrasonic sensor is limited to a non-rectangular form such as a circular form or an elliptical form based on the resonance principle. However, foreign material that adheres to sheets moves in a linear trajectory parallel to the conveying direction. As a result, depending on the position of the foreign material and the position of the ultrasonic sensor, it is possible that the inspection device cannot detect an ultrasonic wave with a high degree of accuracy.

### BRIEF DESCRIPTION OF THE DRAWINGS

FIG. 1 is a perspective view showing the appearance of a sheet handling apparatus in accordance with one embodiment;

FIG. 2 is a diagrammatic front view showing a configuration example of the sheet handling apparatus shown in FIG. 1;

FIG. 3 is a block diagram showing a configuration example of a control system of the sheet handling apparatus shown in FIG. 1 and FIG. 2;

FIG. 4 is a schematic view showing the foreign material detecting device shown in FIG. 2 and FIG. 3;

FIG. 5 is a block diagram showing a configuration of a control system of the foreign material detecting device shown in FIG. 4;

FIG. 6 is a plan view showing a configuration example of a receiving unit and a sound absorbing member of the foreign material detecting device shown in FIG. 4;

FIG. 7 is a plan view to illustrate an example of detecting foreign material by the foreign material detecting device shown in FIG. 4;

FIG. 8 is a plan view to illustrate an example of detecting foreign material by the foreign material detecting device shown in FIG. 4;

FIG. 9 is a graph to illustrate an example of a signal detected by the foreign material detecting device shown in FIG. 4;

FIG. 10 is a graph to illustrate an example of a signal detected by the foreign material detecting device shown in FIG. 4;

FIG. 11 is a plan view showing another configuration example of a receiving unit and a sound absorbing member of the foreign material detecting device shown in FIG. 4;

FIG. 12 is a plan view to illustrate an example of detecting foreign material by the foreign material detecting device shown in FIG. 4;

FIG. 13 is a plan view to illustrate an example of detecting foreign material by the foreign material detecting device shown in FIG. 4;

FIG. 14 is a graph to illustrate an example of a signal detected by the foreign material detecting device shown in FIG. 4;

FIG. 15 is a graph to illustrate an example of a signal detected by the foreign material detecting device shown in FIG. 4;

FIG. 16 is a plan view showing yet another configuration example of a receiving unit and a sound absorbing member of the foreign material detecting device shown in FIG. 4;

FIG. 17 is a plan view showing an example of a receiving unit and a sound absorbing member of the foreign material detecting device shown in FIG. 16;

FIG. 18 is a plan view showing still another configuration example of a receiving unit and a sound absorbing member of the foreign material detecting device shown in FIG. 4;

FIG. 19 is a plan view showing an example of a receiving unit and a sound absorbing member of the foreign material detecting device shown in FIG. 18; and

FIG. 20 is a plan view showing still another configuration example of a receiving unit and a sound absorbing member of the foreign material detecting device shown in FIG. 4.

### DETAILED DESCRIPTION

In general, according to one embodiment, there is provided an ultrasonic line sensor comprising: a plurality of ultrasonic sensors each comprising a non-rectangular vibrating surface and generating an electrical signal in accordance with an ultrasonic wave that enters the vibrating surface; and at least one sound absorbing member that is provided between the vibrating surfaces of the ultrasonic sensors and a detection target, and that absorbs an ultrasonic wave, the sound absorbing member being arranged in a position where the sound absorbing member overlaps both edge portions of the vibrating surfaces in a scanning direction that is perpendicular to a conveying direction of the detection target such that effective regions, which are regions in the vibrating surfaces not overlapped by the sound absorbing member, each have two sides parallel to the conveying direction of the detection target.

Referring to the accompanying drawings, the following is a detailed explanation of an ultrasonic line sensor, and a sheet handling apparatus comprising an ultrasonic line sensor in accordance with one embodiment.

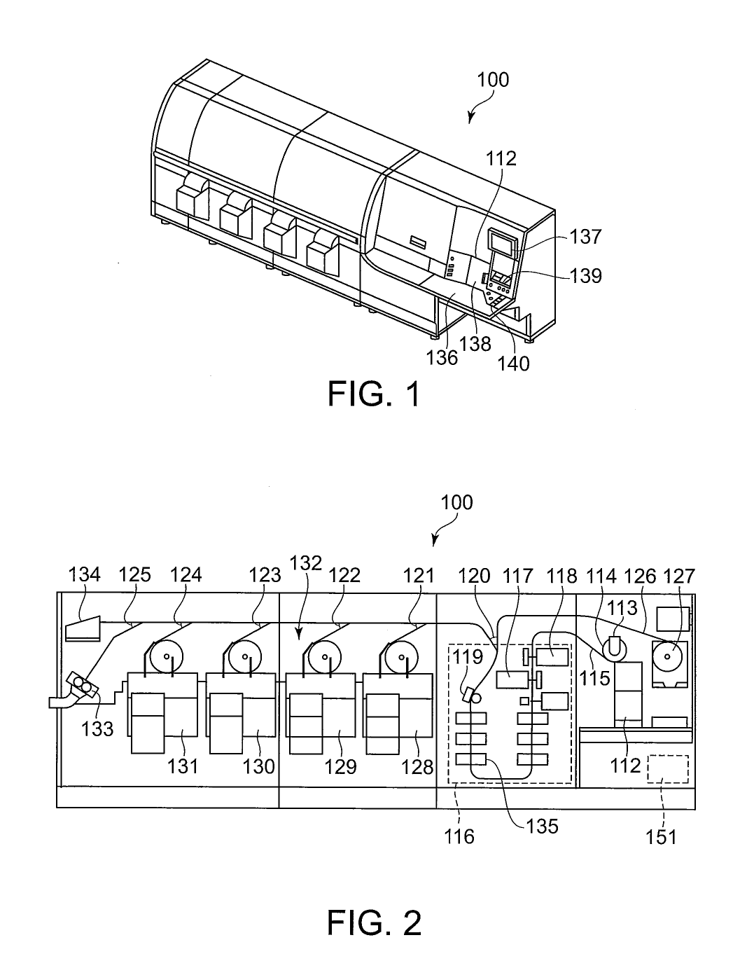

FIG. 1 is a perspective view showing the appearance of a sheet handling apparatus (banknote handling apparatus) 100 in accordance with one embodiment. As shown in FIG. 1, the sheet handling apparatus 100 includes, on the outside of the apparatus, an insert port 112, an operating portion 136, an operation/display portion 137, a door 138, a take-out port 139 and a keyboard 140.

The insert port 112 is configured so that sheets 7, for example banknotes, can be inserted into it. The insert port 112 receives a batch of stacked sheets 7. The operating portion 136 receives various operation inputs from an operator.

The operation/display portion 137 displays various kinds of operation guidance and processing results to the operator. It should be noted that the operation/display portion 137 may also be configured as a touch panel. In this case, the sheet handling apparatus 100 senses various kinds of operation inputs based on buttons that are displayed on the operation/display portion 137, and the operation by the operator on the operation/display portion 137.

The door 138 is for opening and closing the insert opening of the insert port 112. The take-out port 139 is configured to retrieve the sheets 7 from a stack portion where the sheets 7 that have been judged by the sheet handling apparatus 100 to be unfit for recirculation are stacked. The keyboard 140 functions as an input section that receives various kinds of operation input from the operator.

FIG. 2 is a diagrammatic front view showing a configuration example of the sheet handling apparatus 100 shown in FIG. 1. The sheet handling apparatus 100 includes, on the inside of the apparatus, the insert port 112, a take-out port 113, a suction roller 114, a conveying route 115, an inspection portion 116, gates 120 to 125, a rejection sheet conveying route 126, a rejection sheet stacker 127, stack/band portions 128 to 131, a cutting portion 133, and a stacker 134. Moreover, the sheet handling apparatus 100 includes a main controller 151. The main controller 151 performs the integrated control of the operation of the various parts of the sheet handling apparatus 100.

The take-out port 113 is arranged above the insert port 112 for example. The take-out port 113 includes the suction roller 114. The suction roller 114 is provided such that it contacts the sheets 7 placed into the insert port 112 at the upper end in stacking direction. That is to say, by rotating, the suction roller 114 takes in the sheets 7 placed in the insert port 112 one by one from the upper end in stacking direction into the apparatus.

The suction roller 114 functions so as to take out one sheet 7 per rotation, for example. Thus, the suction roller 114 takes out the sheets 7 at constant pitch. The sheets 7 taken out by the suction roller 114 are introduced to the conveying route 115.

Note that the insert port 112, the take-out port 113 and the suction roller 114 are not limited to the above-described configuration. The insert port 112, the take-out port 113 and the suction roller 114 may adopt any configuration as long as the configuration is such that the sheets 7 are taken in one by one into the sheet handling apparatus 100.

The conveying route 115 is a conveying unit for conveying the sheets 7 to the various parts inside the sheet handling apparatus 100. The conveying route 115 is provided with conveying belts and drive pulleys that are not shown in the drawings. The conveying route 115 causes the conveying belts to operate with a drive motor and drive pulleys not shown in the drawings. The conveying route 115 conveys the sheet 7 taken out by the suction roller 114 at a constant speed with the conveying belts. It should be noted that in the following explanations, the side of the conveying route 115 closer to the take-out port 113 is regarded as the “upstream side”, and the side of the conveying route 115 closer to the stacker 134 is regarded as the “downstream side”.

The inspection portion 116 is provided on the conveying route 115 extending from the take-out port 113. The inspection portion 116 includes an image reader 117, an image reader 118, a foreign material detecting device 135, and a thickness inspection portion 119, for example. The inspection portion 116 detects optical feature information, mechanical features, and magnetic feature information of the sheets 7. Thus, the sheet handling apparatus 100 inspects the type, damage and dirt, front and back surface, and the genuineness of the sheets 7.

The image readers 117 and 118 are arranged on opposite sides flanking the conveying route 115. The image readers 117 and 118 read the images of both sides of the sheets 7 that are conveyed along the conveying route 115. The image readers 117 and 118 each include a charge-coupled device (CCD) camera. The sheet handling apparatus 100 obtains pattern images of the front surface and the back surface of the sheets 7, based on the images taken with the image readers 117 and 118.

The image readers 117 and 118 temporarily store the read images in a memory, which is not shown in the drawings, inside the inspection portion 116. The sheet handling apparatus 100 displays the images stored in this memory on the operation/display portion 137, in accordance with the operation input.

The foreign material detecting device 135 irradiates ultrasonic waves onto the conveyed sheet 7, and detects a percolation wave that is transmitted through the sheet 7. Thus, the foreign material detecting device 135 detects the presence of foreign material adhering to the sheet 7, for example. The foreign material detecting device 135 detects, for example, tape or the like stuck to the sheet as foreign material. The foreign material detecting device 135 also detects, for example, stacked sheets 7 (double-fed sheets).

The thickness inspection portion 119 inspects the thickness of the sheets 7 that are conveyed on the conveying route 115. For example, if the detected thickness has at least a predetermined value, the sheet handling apparatus 100 detects that two sheets 7 have been taken out at the same time.

Moreover, the inspection portion 116 includes a magnetic sensor that is not shown in the drawings. This magnetic sensor detects magnetic feature information concerning the sheets 7.

Based on the detection result from the image readers 117, 118, the foreign material detecting device 135, the thickness inspection portion 119, and the magnetic sensor and the like, the main controller 151 judges whether the sheets 7 are intact bills, damaged bills or rejection bills.

The sheet handling apparatus 100 conveys the sheets 7 that have been judged to be intact bills to the stack/band portions 128 to 131. Moreover, the sheet handling apparatus 100 conveys the sheets 7 that have been judged to be damaged bills to the cutting portion 133. The cutting portion 133 cuts the damaged bills conveyed to it. It should be noted that the sheet handling apparatus 100 may also convey the damaged bills to the stacker 134 and stack them there. The stacker 134 applies a wrapper to damaged bills every time that for example 100 stacked damaged bills have arrived.

The rejection bills are sheets 7 that are neither intact bills nor damaged bills. The sheet handling apparatus 100 conveys the sheets 7 that have been judged to be rejection bills to the rejection sheet stacker 127. Rejection bills are for example improperly conveyed bills, such as double take-outs, defective bills, such as folded or ripped bills, and bills that could not be discriminated, such as wrong bill types or counterfeit bills.

The gates 120 to 125 are arranged in order along the conveying route 115 on the downstream side of the inspection portion 116. The gates 120 to 125 are each controlled by the main controller 151. The main controller 151 controls the operation of the gates 120 to 125 based on the inspection result from the inspection portion 116. Thus, the main controller 151 performs the control such that the sheets 7 conveyed on the conveying route 115 are conveyed to a predetermined processing portion.

The gate 120 arranged immediately behind the inspection portion 116 branches the conveying route 115 to the rejection sheet conveying route 126. That is to say, the gate 120 is switched such that the rejection bills that have been judged not to be legitimate bills as a result of the inspection with the inspection portion 116, the bills that could not be inspected by the inspection portion 116 and the like are conveyed to the rejection sheet conveying route 126.

The rejection sheet stacker (rejection portion) 127 is provided at the rear end of the rejection sheet conveying route 126. The rejection sheet stacker 127 stacks the above-noted rejection bills, and bills that could not be inspected and so on mentioned above, in the orientation in which they were taken out from the take-out port 113. The sheets 7 stacked in the rejection sheet stacker 127 can be taken out from the take-out port 139.

Moreover, the stack/band portions 128 to 131 (collectively referred to as “stack/band portion 132”) are provided respectively behind the branching of the gates 121 to 124. The sheets 7 that have been judged to be fit for recirculation are stacked in the stack/band portion 132, sorted by type and front/back side. The stack/band portion 132 bands and stores the stacked sheets 7 in packs of a predetermined number. Moreover, every predetermined number of packs, the sheet handling apparatus 100 stacks and bands a plurality of packs of sheets 7 with a large-pack band portion, not shown in the drawings.

The cutting portion 133 is arranged at one end of the conveying route 115 branched by the gate 125. The cutting portion 133 cuts and stores sheets 7. The sheets 7 that are conveyed by the gate 125 are legitimate sheets 7 that have been judged to be unfit for recirculation (damaged bills).

The stacker 134 is placed at the other end of the conveying route 115 branched by the gate 125. If the damaged bill cutting mode is selected, the main controller 151 controls the gate 125 such that the sheets 7 are conveyed to the cutting portion 133. And if the damaged bill cutting mode is not selected, the main controller 151 controls the gate 125 such that the sheets 7 are conveyed to the stacker 134.

The main controller 151 successively stores the number of sheets 7 stacked by the stack/band portion 132, the number of sheets 7 cut by the cutting portion 133, and identification information.

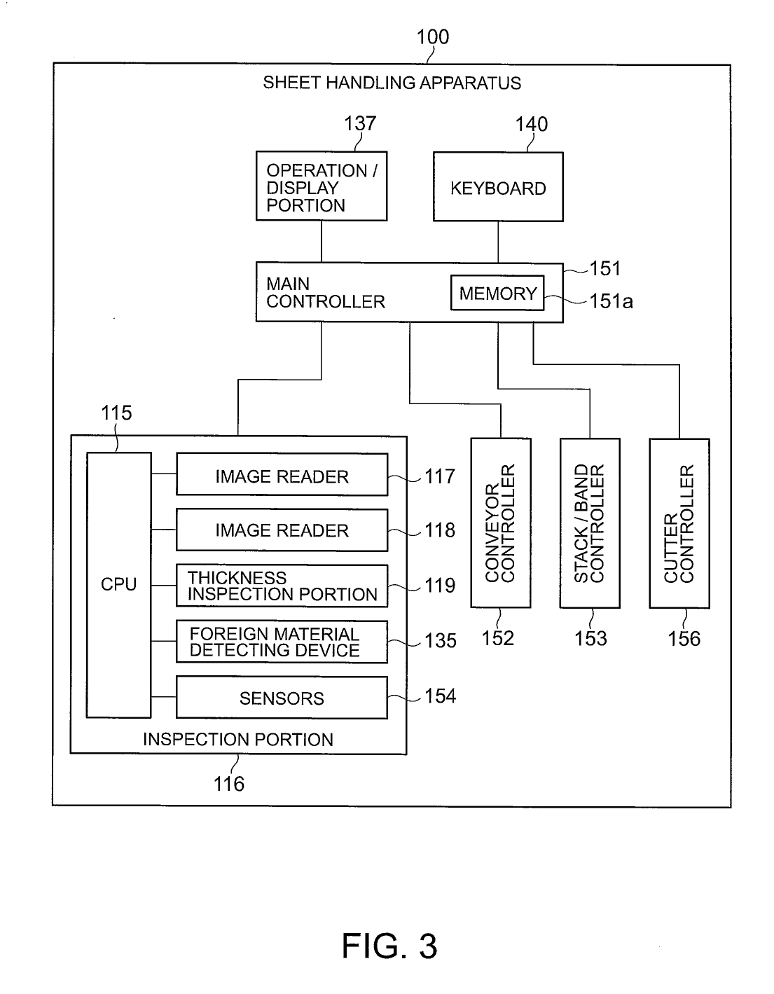

FIG. 3 is a block diagram showing a configuration example of a control system of the sheet handling apparatus 100 shown in FIG. 1 and FIG. 2.

The sheet handling apparatus 100 includes the main controller 151, the inspection portion 116, a conveyor controller 152, a stack/band controller 153, a cutter controller 156, the operation/display portion 137, and the keyboard 140.

The main controller 151 performs the overall control of the sheet handling apparatus 100. The main controller 151 controls the conveyor controller 152 and the stack/band controller 153 based on the commands entered into the operation/display portion 137 and the inspection result from the inspection portion 116.

For example, an operator may enter the bill type and number, the intactness discrimination level, the name of the supplier and the processing method of the processed sheets 7 with the operation/display portion 137 or the keyboard 140.

The inspection portion 116 includes the image readers 117 and 118, the thickness inspection portion 119, the foreign material detecting device 135, other sensors 154 and a CPU 155.

The image readers 117 and 118 read an image from both sides of the sheets 7 that are conveyed on the conveying route 115. The image readers 117 and 118 include a light-receiving element, such as a CCD, and an optical system. The image readers 117 and 118 project light onto the conveyed sheets 7 and receive the reflected light or the transmitted light with the optical system. The image readers 117 and 118 image the light received with the optical system onto the CCD and obtain an electric signal (image).

The main controller 151 stores an image (reference image) serving as a reference for the sheet 7 in advance in a memory 151a. The main controller 151 subjects the sheets to an intactness judgment and a counterfeit bill judgment by comparing the image obtained from the sheets 7 with the reference image stored in the memory 151a.

As described above, the foreign material detecting device 135 irradiates ultrasonic waves onto the conveyed sheets 7. The foreign material detecting device 135 detects the sonic waves that are transmitted through the sheets 7. Furthermore, the foreign material detecting device 135 stores a pre-set reference value.

If foreign material adheres to a sheet 7, then the intensity of the ultrasonic wave that is transmitted through the sheet 7 (percolation wave) is attenuated. The foreign material detecting device 135 compares the intensity of the detected percolation wave (percolation wave intensity) with the pre-stored reference value. Based on the comparison result, the foreign material detecting device 135 determines whether foreign material adheres to the sheet 7.

The thickness inspection portion 119 inspects the thickness of the sheets 7 that are conveyed on the conveying route 115. The other sensors 154 are for example magnetic sensors or the like. The magnetic sensors detect information on magnetic features from the sheets 7 that are conveyed on the conveying route 115.

Based on the result of the inspection with the image readers 117 and 118, the thickness inspection portion 119, the foreign material detecting device 135, and the other sensors 154, the CPU 155 discriminates the type, the intactness, the front and back surface and the genuineness of the sheets 7 that are conveyed on the conveying route 115.

Based on the control of the main controller 151, the conveyor controller 152 controls the take-out port 113, the conveying route 115, the rejection sheet conveying route 126, and the gates 120 to 125. Accordingly, the conveyor controller 152 controls the take-out and the conveying of the sheets 7. Moreover, the conveyor controller 152 performs a sorting process, in which the judged sheets 7 are sorted by type. That is to say, the conveyor controller 152 functions as a sorting processor.

For example, if the foreign material detecting device 135 detects that foreign material adheres to a sheet 7, then the conveyor controller 152 controls the gates 120 to 125 such that the sheet 7 is conveyed to the rejection sheet stacker 127, the cutting portion 133 or the stacker 134.

The stack/band controller 153 controls the rejection sheet stacker 127 and the stack/band portions 128 to 131 based on the control of the main controller 151. Thus, the stack/band controller 153 controls the stacking and the banding of the sheets 7.

The cutter controller 156 controls the operation of the cutting portion 133 based on the control of the main controller 151. Thus, the cutting portion 133 performs the cutting of the conveyed sheets 7.

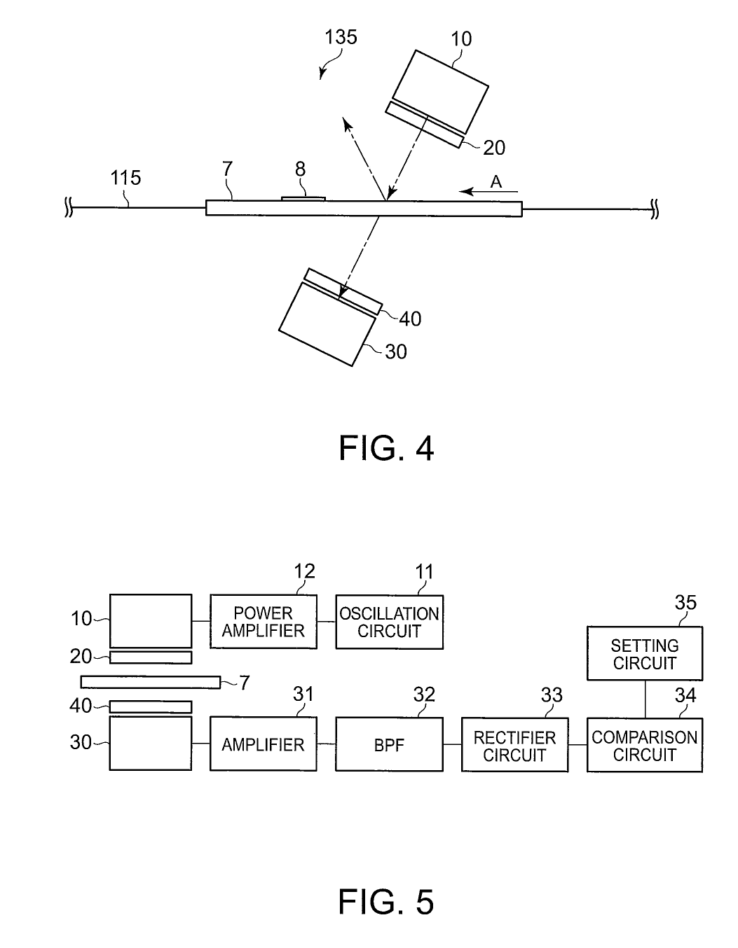

FIG. 4 is a schematic view showing a configuration example of the foreign material detecting device 135 shown in FIG. 2 and FIG. 3. The sheet 7 is for example held between the conveying belts not shown in the drawings, and conveyed in the direction of arrow A shown in FIG. 4. The foreign material detecting device 135 performs a detection process to detect foreign material 8, such as a tape, or a piece of paper adhering to the sheet 7. Thus, the foreign material detecting device 135 detects the presence of foreign material 8 adhering to the sheet 7. The foreign material detecting device 135 is placed near the conveying route 115 of the sheet handling apparatus 100, for example.

As shown in FIG. 4, the foreign material detecting device 135 includes a transmission unit 10 and a receiving unit 30. The transmission unit 10 includes a sound absorbing member 20 provided on the vibrating surface of the transmission unit 10. In addition, the receiving unit 30 includes a sound absorbing member 40 provided on the vibrating surface of the receiving unit 30.

The transmission unit 10 includes an ultrasonic sensor. The ultrasonic sensor irradiates an ultrasonic wave onto the sheet 7 conveyed at a constant speed in the conveying direction A. The ultrasonic sensor includes a piezoelectric element and a vibrating surface. By applying a voltage to the piezoelectric element of the ultrasonic sensor, the transmission unit 10 changes the shape of the piezoelectric body.

For example, by applying a pulse signal to the piezoelectric element, the transmission unit 10 changes the shape of the piezoelectric element cyclically. The transmission unit 10 thus causes the vibrating surface to vibrate. As a result, transmission unit 10 can emit into the air ultrasonic waves in accordance with the cycle length of the pulse signal.

The sound absorbing member 20 is formed by a material that absorbs waves for example. The sound absorbing member 20 limits the output range of the ultrasonic waves output from the transmission unit 10, for example. Consequently, the transmission unit 10 can cause an ultrasonic wave to enter a predetermined area in the sheet 7 conveyed on the conveying route 115.

The receiving unit 30 includes an ultrasonic sensor similar to that of the transmission unit 10. The ultrasonic sensor includes a piezoelectric element having a circular surface and a vibrating surface. The ultrasonic sensor of the receiving unit 30 generates an electric signal corresponding to the change of the shape of its piezoelectric element.

If an ultrasonic wave is caused to enter the vibrating surface of the receiving unit 30, the vibrating surface vibrates in accordance with the entered ultrasonic wave. If the vibration surface vibrates, the piezoelectric element of the receiving unit 30 changes its shape in accordance with the entered ultrasonic wave. As a result, the receiving unit 30 generates an electric signal corresponding to the cycle length and the intensity of the ultrasonic wave.

The receiving unit 30 is arranged such that the vibrating surface of the ultrasonic sensor of the receiving unit 30 opposes the vibrating surface of the ultrasonic sensor of the transmission unit 10. That is, when the sheet 7 is not present in the detection range of the ultrasonic sensor of the receiving unit 30, the receiving unit 30 directly receives the ultrasonic wave output from the transmission unit 10.

When the sheet 7 is present in the detection range of the ultrasonic sensor of the receiving unit 30, the ultrasonic wave output from the transmission unit 10 is divided into a reflection wave that is reflected on the sheet 7 and a percolation wave that is transmitted through the sheet 7. In this case, the receiving unit 30 receives a percolation wave that is transmitted through the sheet 7.

Furthermore, when the sheet 7 and the foreign material 8 are present in the detection range of the ultrasonic sensor of the receiving unit 30, the receiving unit 30 receives a percolation wave that is output from the transmission unit 10 and is transmitted through the sheet 7 and the foreign material 8. When the ultrasonic wave is transmitted through foreign material, the amplitude of the percolation wave is reduced.

The sound absorbing member 40 is formed of a sound absorbing material similar to the sound absorbing member 20 for example. The sound absorbing member 40 limits, for example, the ultrasonic wave that enters the vibrating surface of the receiving unit 30. Specifically, the sound absorbing member 40 limits the range in the vibrating surface of the receiving unit 30 through which the ultrasonic wave output from the transmission unit 10 can enter. The sound absorbing member 40 can thus limit the range in the vibrating surface of the receiving unit 30 through which the ultrasonic wave enters.

In addition, by adjusting the shape of the sound absorbing member 40, it is possible to freely adjust the shape of the range in the vibrating surface of the receiving unit 30 through which the ultrasonic wave can enter. In other words, the sound absorbing member 40 can freely adjust the detection range of the ultrasonic sensor of the receiving unit 30.

It should be noted that the transmission unit 10 is placed at an angle with which the transmission unit 10 is not affected by reflected waves that are reflected at the surface of the conveyed sheet 7. Also, the position of the receiving unit 30 is adjusted in accordance with the angle at which the transmission unit 10 is placed.

FIG. 5 is a block diagram showing a configuration example of a control system of the foreign material detecting device 135 shown in FIG. 4.

As shown in FIG. 5, the foreign material detecting device 135 includes the transmission unit 10, an oscillation circuit 11, a power amplifier 12, the receiving unit 30, an amplifier 31, a band-pass filter (BPS) 32, a rectifier circuit 33, a comparison circuit 34, and a setting circuit 35. Furthermore, the foreign material detecting device 135 includes a controller that is not shown in the drawings.

The controller controls operation of various parts of the foreign material detecting device 135. The controller includes, for example, a CPU, a buffer memory, a program memory and a non-volatile memory.

The CPU carries out various kinds of arithmetic processing. The buffer memory temporarily stores the results computed by the CPU. The program memory and the non-volatile memory store various kinds of programs executed by the CPU as well as control data.

The controller can perform various kinds of processes by executing a program stored in the program memory with the CPU. For example, the controller controls the operation timing of the transmission unit 10 and the receiving unit 30.

The controller is connected to the CPU 155 of the inspection portion 116 and the main controller 151 shown in FIG. 3. For example, the controller notifies processing results to the main controller 151 or the CPU 155. Moreover, the controller controls the operation of the foreign material detecting device 135 based on the control signals sent from the main controller 151 or the CPU 155.

The oscillation circuit 11 generates an AC (alternating-current) voltage of, for example, 300 kHz to 400 kHz. The oscillation circuit 11 outputs the generated AC voltage to the power amplifier 12.

The power amplifier 12 amplifies the AC voltage supplied from the oscillation circuit 11. The power amplifier 12 outputs the amplified AC voltage to the transmission unit 10.

The transmission unit 10 applies the AC voltage supplied from the power amplifier 12 to the piezoelectric element of the ultrasonic sensor. The transmission unit 10 thus outputs an ultrasonic wave.

As described above, when the sheet 7 is not present in the detection range of the ultrasonic sensor of the receiving unit 30, the ultrasonic wave output from the transmission unit 10 directly enters the receiving unit 30. When the sheet 7 is present in the detection range of the ultrasonic sensor of the receiving unit 30, the percolation wave that is output from the transmission unit 10 and is transmitted through the sheet 7 enters the receiving unit 30.

The receiving unit 30 generates an electric signal corresponding to the entered ultrasonic wave. That is, the receiving unit 30 generates a signal indicating the intensity of the ultrasonic wave (intensity signal). The receiving unit 30 outputs the generated intensity signal to the amplifier 31.

The amplifier 31 amplifies the intensity signal supplied from the receiving unit 30. The amplifier 31 outputs the amplified intensity signal to the band-pass filter 32.

The band-pass filter 32 removes noise components in the intensity signal supplied from the amplifier 31. The band-pass filter 32 outputs the intensity signal from which noise components have been removed to the rectifier circuit 33.

The rectifier circuit 33 converts the AC intensity signal into a DC signal.

The rectifier circuit 33 outputs the intensity signal converted to DC to the comparison circuit 34.

The comparison circuit 34 compares the intensity signal supplied from the rectifier circuit 33 with a comparison reference value that is set in advance in the setting circuit 35. For example, in the case where the intensity signal supplied from the rectifier circuit 33 is less than the comparison reference value set in the setting circuit 35, the comparison circuit 34 outputs a detection signal indicating that foreign material adheres to the sheet 7. In this case, the controller of the foreign material detecting device 135 outputs the detection signal to the CPU 155 or the main controller 151 shown in FIG. 3.

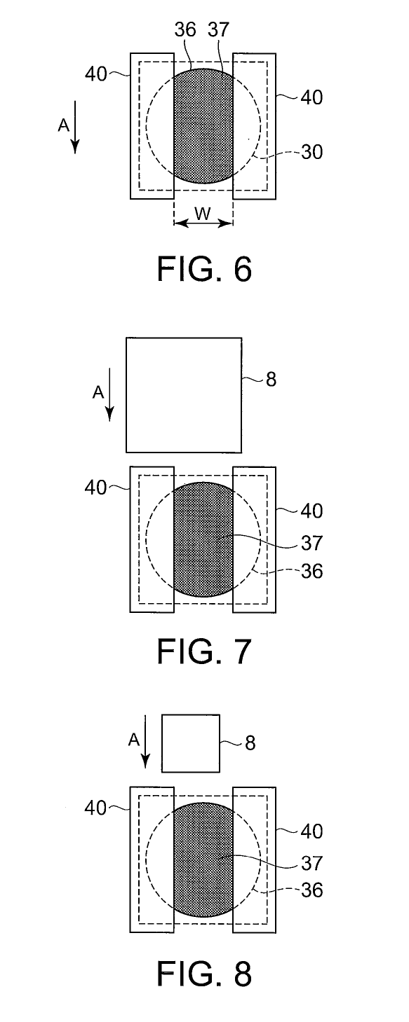

FIG. 6 is a plan view showing a configuration example of the receiving unit 30 and the sound absorbing members 40 of the foreign material detecting device 135 shown in FIG. 4. As shown in FIG. 6, the receiving unit 30 includes an ultrasonic sensor 36 having a circular surface. The ultrasonic sensor 36 includes a circular vibrating surface 37 for receiving ultrasonic waves. The vibrating surface 37 is not limited to a circular form, and may have any form as long as the form is a non-rectangular, form such as an elliptical form. In addition, sound absorbing members 40 are arranged between the vibrating surface 37 and the conveying route 115.

The sound absorbing members 40 are rectangular members having sides that are parallel to the conveying direction A of the sheet 7 and have a length equal to or longer than the diameter of the vibrating surface 37. For example, the sound absorbing members 40 are placed so as to cover the edge portions of the vibrating surface 37 in the direction (scanning direction) perpendicular to the conveying direction A, as shown in FIG. 6. As a result, an ultrasonic wave that is output from the transmission unit 10 enters only the doted area of the vibrating surface 37.

Specifically, the sound absorbing members 40 are arranged so as to maintain a constant width w in the scanning direction of the effective region in the vibrating surface 37 of the ultrasonic sensor 36 in the receiving unit 30.

Although the sound absorbing members 40 have been described as rectangular members whose sides parallel to the conveying direction A of the sheet 7 have a length equal to or longer than the diameter of the vibrating surface 37, there is no limitation to such a configuration. The sound absorbing members 40 may have any form as long as the sound absorbing members 40 can, at least, cover the edge portions of the vibrating surface 37 of the ultrasonic sensor 36, and maintain a constant width in the scanning direction of the effective region of the vibrating surface 37.

FIG. 7 and FIG. 8 are plan views to illustrate an example of detecting the foreign material 8 by the receiving unit 30 shown in FIG. 6. Note that in the example shown in FIG. 7, the length of the foreign material 8 in the conveying direction A is the same as the diameter of the vibrating surface 37. FIG. 8 shows an example in which the length of the foreign material 8 in the conveying direction A is half the diameter of the vibrating surface 37.

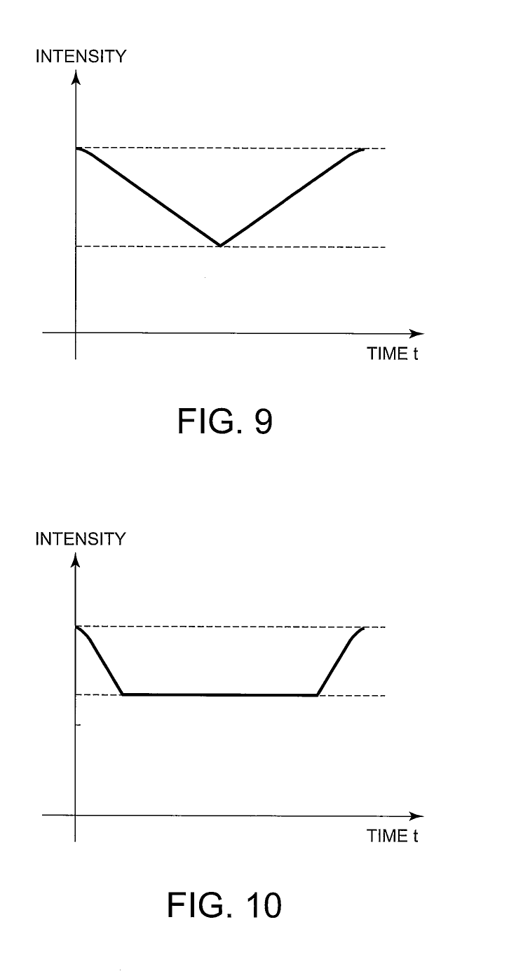

FIG. 9 shows a graph to illustrate an example of a signal detected by the receiving unit 30 in the example shown in FIG. 7.

In the graph shown in FIG. 9, the vertical axis marks the intensity (sensor output) of the ultrasonic wave detected by the ultrasonic sensor 36 of the receiving unit 30, while the horizontal axis marks elapsed time t. Note that the sheet 7 is conveyed at a constant speed in the conveying direction A, and therefore the horizontal axis also may mark the conveying distance (position) of the sheet 7 or the foreign material 8 instead.

As shown in FIG. 7, the scanning width in the vibrating surface 37 is constant except for those locations where an edge portion of the foreign material 8 overlaps an edge portion in the conveying direction A of the vibrating surface 37. Therefore, as shown in FIG. 9, the receiving unit 30 can detect the intensity of the percolation wave as varying linearly depending on the position of the foreign material 8.

Note that the length of the foreign material 8 in the conveying direction A is assumed to be the same as the diameter of the vibrating surface 37. Accordingly, the foreign material 8 always overlaps one edge portion in the conveying direction A of the vibrating surface 37. Therefore, the percolation wave that enters the effective region in the vibrating surface 37 varies continuously. That is, the receiving unit 30 detects a signal that varies continuously, as shown in FIG. 9.

FIG. 10 shows a graph to illustrate an example of a signal detected by the receiving unit 30 in the example shown in FIG. 8.

In the graph shown in FIG. 10, the vertical axis marks the intensity (sensor output) of the ultrasonic wave detected by the ultrasonic sensor 36 of the receiving unit 30, while the horizontal axis marks elapsed time t. Note that the sheet 7 is conveyed at a constant speed in the conveying direction A, and therefore the horizontal axis also may mark the conveying distance (position) of the sheet 7 or the foreign material 8 instead.

As shown in FIG. 8, the scanning width in the vibrating surface 37 is constant except for those locations where an edge portion of the foreign material 8 overlaps an edge portion in the conveying direction A of the vibrating surface 37. Therefore, as shown in FIG. 10, the receiving unit 30 can detect the intensity of the percolation wave as varying linearly depending on the position of the foreign material 8.

The length of the foreign material 8 in the conveying direction A is assumed to be half the length of the diameter of the vibrating surface 37. Accordingly, there is a time period t in which the foreign material 8 does not overlap an edge portion in the conveying direction A of the vibrating surface 37. When the foreign material 8 does not overlap the edge portions in the conveying direction A of the vibrating surface 37, the percolation wave that enters the effective region in the vibrating surface 37 does not vary. Therefore, the receiving unit 30 detects a signal at a constant level, as shown in FIG. 10.

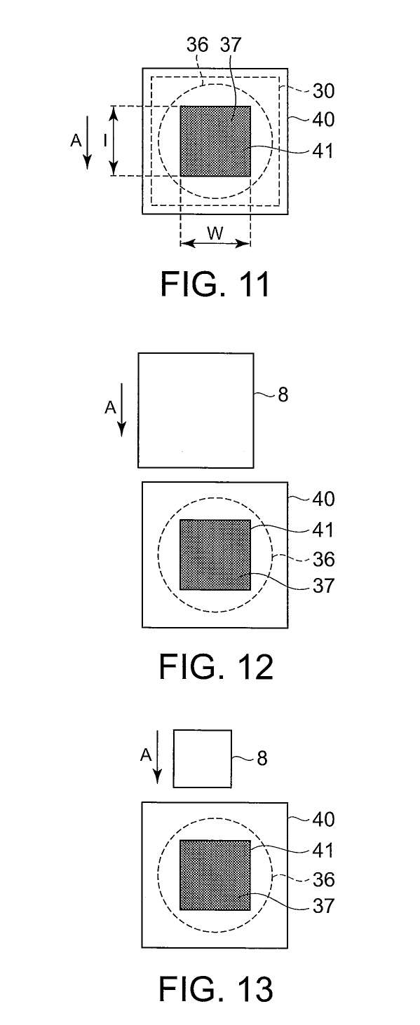

FIG. 11 is a plan view of another configuration example of the receiving unit 30 and the sound absorbing member 40 of the foreign material detecting device 135 shown in FIG. 4. As shown in FIG. 11, the receiving unit 30 includes an ultrasonic sensor 36. The ultrasonic sensor 36 includes a vibrating surface 37 for receiving ultrasonic waves. Furthermore, a sound absorbing member 40 is provided between the vibrating surface 37 and the conveying route 115.

The sound absorbing member 40 is a rectangular member whose sides have a length equal to or longer than the diameter of the vibrating surface 37. The sound absorbing member 40 includes an opening portion 41. The opening portion 41 is provided in a rectangular form within a region where the opening portion 41 overlaps the vibrating surface 37 of the ultrasonic sensor 36. As a result, an ultrasonic wave output from the transmission unit 10 enters only in the area (effective region) in the vibrating surface 37 overlapped by the opening portion 41. In FIG. 11, the effective region is indicated with dots.

Specifically, the sound absorbing member 40 is arranged so as to maintain a constant width W in the scanning direction and a constant length 1 in the conveying direction A of the effective region in the vibrating surface 37 of the ultrasonic sensor 36 of the receiving unit 30.

FIG. 12 and FIG. 13 are plan views to illustrate an example of detecting the foreign material 8 by the receiving unit 30 shown in FIG. 11. Note that in the example shown in FIG. 12, the length of the foreign material 8 in the conveying direction A is the same as the diameter of the vibrating surface 37. Alternatively, FIG. 13 shows an example in which the length of the foreign material 8 in the conveying direction A is half the diameter of the vibrating surface 37.

As shown in FIG. 12, in the case where the foreign material 8, which is larger than the effective region in the vibrating surface 37 of the receiving unit 30, passes, the time period in which the attenuation of the percolation wave occurs becomes shorter, but the time period in which the percolation wave is attenuated to a maximum extent becomes longer. Therefore, it can be said that the example shown in FIG. 12 is a more suitable form for detecting the foreign material 8 than that shown in FIG. 7.

Also, as shown in FIG. 13, in the case where the foreign material 8, which is smaller than the effective region in the vibrating surface 37 of the receiving unit 30, passes, the attenuation of the intensity of the percolation wave is more pronounced than in the example shown in FIG. 8. In addition, the time period in which the percolation wave is attenuated to a maximum extent becomes longer. Therefore, it can be said that the example shown in FIG. 13 is a more suitable form for detecting the material 8 than that shown in FIG. 8.

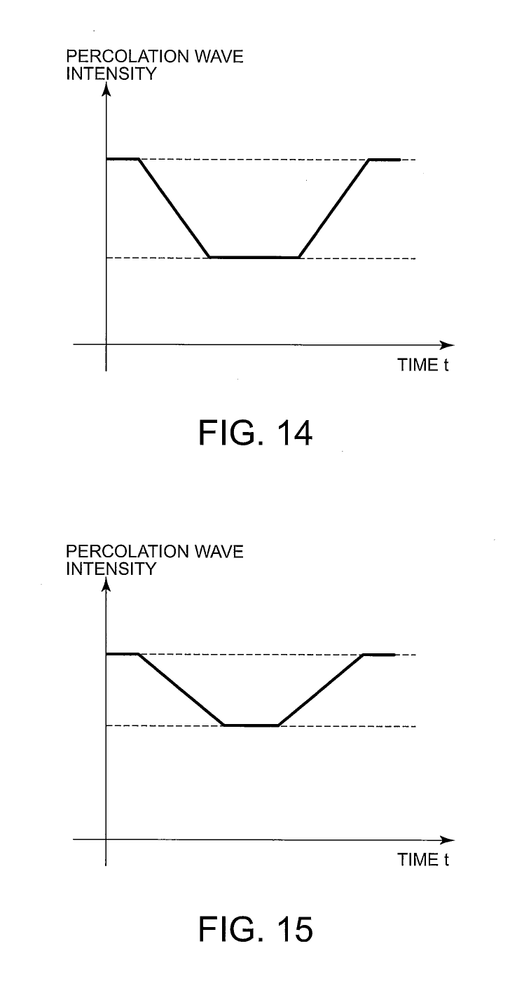

FIG. 14 is a graph to illustrate an example of a signal detected by the receiving unit 30 in the example shown in FIG. 12.

In the graph shown in FIG. 14, the vertical axis marks the intensity (sensor output) of the ultrasonic wave detected by the ultrasonic sensor 36 of the receiving unit 30, while the horizontal axis marks elapsed time t. Note that the sheet 7 is conveyed at a constant speed in the conveying direction A, and therefore the horizontal axis also may mark the conveying distance (position) of the sheet 7 or the foreign material 8 instead.

As shown in FIG. 12, the scanning width in the vibrating surface 37 is constant. Therefore, as shown in FIG. 14, the receiving unit 30 can detect the intensity of the percolation wave that varies linearly depending on the position of the foreign material 8.

Note that the length of the foreign material 8 in the conveying direction A is assumed to be the same as the diameter of the vibrating surface 37. Therefore, the length of this rectangular opening portion 41 in the conveying direction A is shorter than the length of the foreign material 8 in the conveying direction A. Accordingly, there is a time period t. in which the edge portions in conveying direction A of the foreign material 8 are not within the range of the opening portion 41. When the edge portions in conveying direction A of the foreign material 8 are not within the range of the opening portion 41, the percolation wave that enters the effective region in the vibrating surface 37 does not vary. Therefore, the receiving unit 30 detects a signal at a constant level, as shown in FIG. 14.

FIG. 15 is a graph to illustrate an example of a signal detected by the receiving unit 30 in the example shown in FIG. 13.

In the graph shown in FIG. 15, the vertical axis marks the intensity (sensor output) of the ultrasonic wave detected by the ultrasonic sensor 36 of the receiving unit 30, while the horizontal axis marks elapsed time t. Note that the sheet 7 is conveyed at a constant speed in the conveying direction A, and therefore the horizontal axis also may mark the conveying distance (position) of the sheet 7 or the foreign material 8 instead.

As shown in FIG. 13, the scanning width in the vibrating surface 37 is constant. Therefore, as shown in FIG. 15, the receiving unit 30 can detect the intensity of the percolation wave as varying linearly depending on the position of the foreign material 8.

Note that the length of the foreign material 8 in the conveying direction A is assumed to be half the diameter of the vibrating surface 37. For example, when the length of the foreign material 8 in the conveying direction A is shorter than the length of the rectangular opening portion 41 in the conveying direction A, there is a time period t in which the foreign material 8 does not overlap the edge portions in the conveying direction A of the opening portion 41. When the foreign material 8 does not overlap the edge portions in the conveying direction A of the opening portion 41, the percolation wave that enters the effective region in the vibrating surface 37 does not vary. Therefore, the receiving unit 30 detects a signal at a constant level, as shown in FIG. 15.

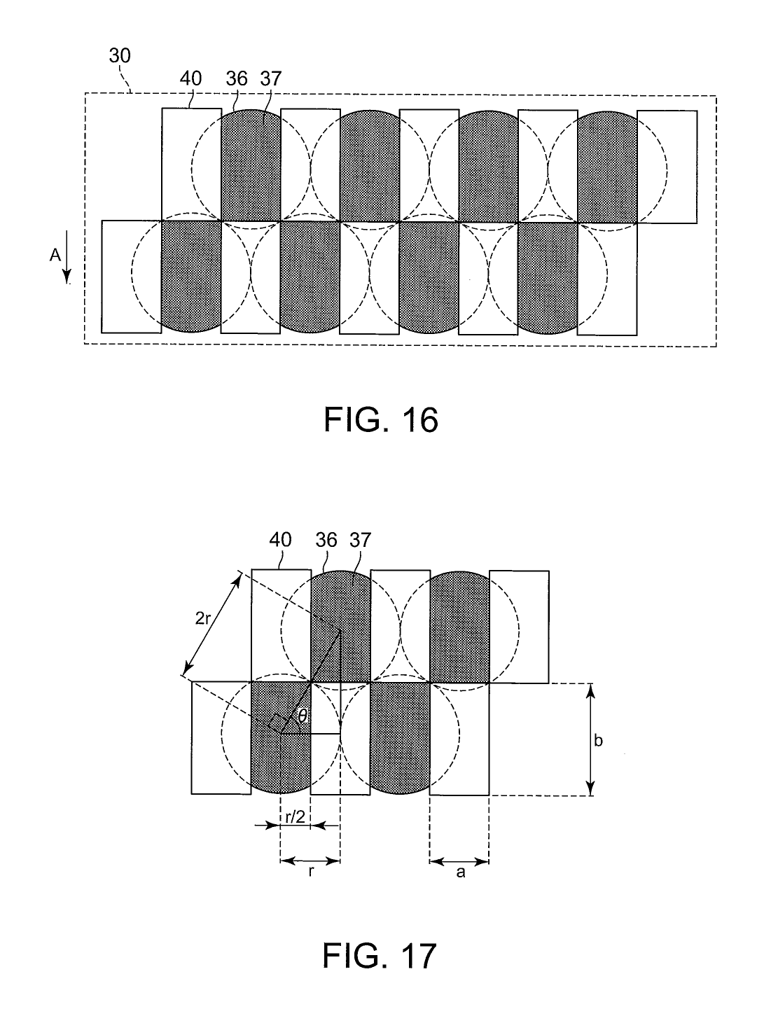

FIG. 16 is to illustrate yet another configuration example of the receiving unit 30 and the sound absorbing member 40 of the foreign material detecting device 135 shown in FIG. 4.

As shown in FIG. 16, the receiving unit 30 includes a plurality of ultrasonic sensors 36. The receiving unit 30 further includes a plurality of sound absorbing members 40 provided between vibrating surfaces 37 of the plurality of ultrasonic sensors 36 and the conveying route 115.

The ultrasonic sensors 36 are placed alternately in two rows, in a closest packed arrangement. The sound absorbing members 40 are arranged such that the scanning areas of the ultrasonic sensors 36 do not mutually overlap in the conveying direction A or in the scanning direction. In addition, the sound absorbing members 40 are arranged such that no non-sensing area (unsensed area) is present between the scanning areas of the ultrasonic sensors 36. Specifically, the sound absorbing members 40 are arranged such that the scanning areas based on the effective regions in the vibrating surfaces 37 are continuous in the scanning direction.

As described above, the receiving unit 30 includes an ultrasonic line sensor that has a plurality of ultrasonic sensors 36 and a plurality of sound absorbing members 40.

FIG. 17 is to illustrate an example of the receiving units 30 and the sound absorbing members 40 of the foreign material detecting device 135 shown in FIG. 16.

As shown in FIG. 17, the plurality of the ultrasonic sensors 36 of the receiving unit 30 are placed in a closest packed arrangement. That is, the plurality of ultrasonic sensors 36 of the receiving unit 30 are placed such that the circumference of the vibrating surface 37 of an ultrasonic sensor 36 is as close as possible to the circumferences of the vibrating surfaces 37 of adjacent ultrasonic sensors 36.

For example, if the radius of the vibrating surface 37 of the ultrasonic sensor 36, which is determined by taking its fixing frame (not shown in the drawings) into consideration, is r, the width in the scanning direction of the sound absorbing member 40 is a, and the length in the conveying direction A of the sound absorbing member 40 is b, then the distance between the center of the vibrating surface 37 of one ultrasonic sensor 36 and the center of the vibrating surface 37 adjacent in the conveying direction A is 2r.

Also in this case, the angle θ formed by the scanning direction and the line segment formed by the center of the vibrating surface 37 of one ultrasonic sensor 36 and the center of the vibrating surface 37 adjacent in the conveying direction A is 60°. Specifically, the distance in the scanning direction from the center of the vibrating surface 37 of one ultrasonic sensor 36 to the end of the sound absorbing member 40 is r/2.

As a result, it can be derived that the width a in the scanning direction of the sound absorbing member 40 is equal to the radius r of the vibrating surface 37. In this case, it is further derived that the length b of the sound absorbing member 40 in the conveying direction A is 2r×sin 60°.

Also, it can be derived that the distance in the conveying direction A between the center of the vibrating surface 37 of one ultrasonic sensor 36 and the center of the vibrating surface 37 adjacent in the conveying direction A is also 2r×sin 60°.

As described above, by providing a plurality of ultrasonic sensors 36 and sound absorbing members 40, the foreign material detecting device 135 can detect foreign material and double-fed sheets with a higher resolution. Also, the sound absorbing members 40 are provided to cover the edge portions in the scanning direction of the vibrating surface 37. As a result, it is possible to prevent the edge portions in the scanning direction of the vibrating surface 37 that are not suitable for detecting an ultrasonic wave from affecting the detection results.

As a result, it is possible to provide an ultrasonic line sensor capable of detecting an ultrasonic wave with a higher degree of accuracy and a sheet handling apparatus including such an ultrasonic line sensor.

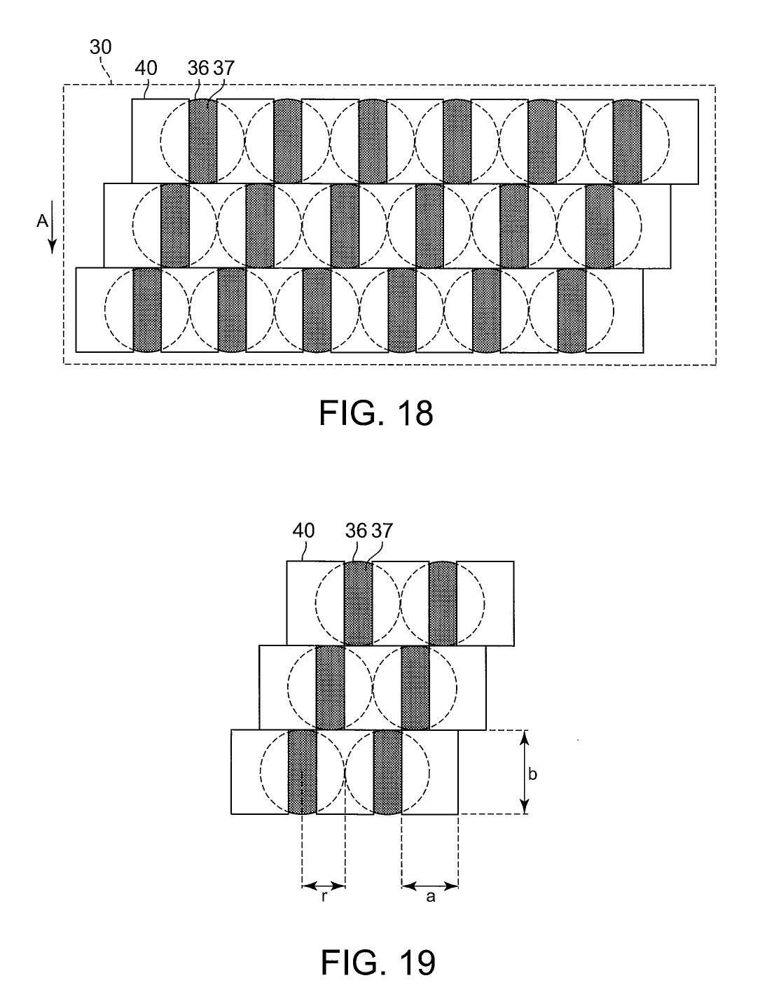

FIG. 18 is to illustrate yet another configuration example of the receiving unit 30 and the sound absorbing member 40 of the foreign material detecting device 135 shown in FIG. 4.

As shown in FIG. 18, the receiving unit 30 includes a plurality of ultrasonic sensors 36. Furthermore, the receiving unit 30 includes a plurality of sound absorbing members 40 provided between vibrating surfaces 37 of the plurality of ultrasonic sensors 36 and the conveying route 115.

The ultrasonic sensors 36 are placed alternately in three rows, in a closest packed arrangement. The sound absorbing members 40 are arranged such that the scanning areas of the ultrasonic sensors 36 do not mutually overlap in the conveying direction A or in the scanning direction. In addition, the sound absorbing members 40 are arranged such that no non-sensing area is present between the scanning areas of the ultrasonic sensors 36. Specifically, the receiving unit 30 includes an ultrasonic line sensor provided with a plurality of ultrasonic sensors 36 and a plurality of sound absorbing members 40.

FIG. 19 is a plan view showing an example of the receiving unit 30 and the sound absorbing members 40 of the foreign material detecting device 135 shown in FIG. 18.

As shown in FIG. 19, the plurality of ultrasonic sensors 36 and the plurality of sound absorbing members 40 of the receiving unit 30 are arranged such that when the ultrasonic sensors 36 are arrayed in three rows, the effective region of the vibrating surface 37 is a maximum.

For example, the radius of the vibrating surface 37 of the ultrasonic sensor 36 is assumed to be r, the width in the scanning direction of the sound absorbing member 40 is assumed to be a, and the length in the conveying direction A of the sound absorbing member 40 is assumed to be b.

In this case, in order to maximize the sensing area, the width a in the scanning direction of the sound absorbing member 40 can be expressed as 4r/3. Also, the length b in the conveying direction A of the sound absorbing member 40 can be expressed as b=\sqrt{{a²+(2r)²}}.

By arraying the plurality of ultrasonic sensors 36 and the plurality of sound absorbing members 40 in three rows as described above, the foreign material detecting device 135 can detect foreign material and double-fed sheets with a higher resolution. As a result, it is possible to provide an ultrasonic line sensor capable of detecting an ultrasonic wave with a higher degree of accuracy and a sheet handling apparatus including such an ultrasonic line sensor.

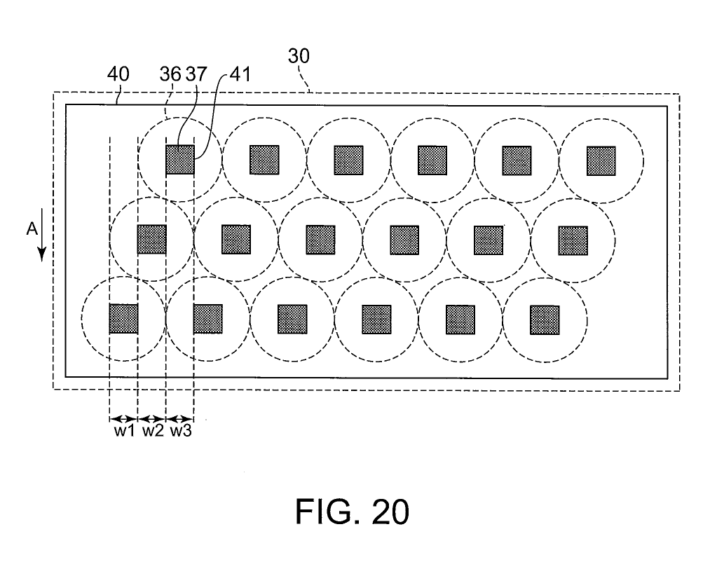

FIG. 20 is a plan view showing still another configuration example of the receiving unit 30 and the sound absorbing member 40 of the foreign material detecting device 135 shown in FIG. 4.

As shown in FIG. 20, the receiving unit 30 includes a plurality of ultrasonic sensors 36. The receiving unit 30 further includes a (one) sound absorbing member 40 including a plurality of opening portions 41 provided between vibrating surfaces 37 of the plurality of ultrasonic sensors 36 and the conveying route 115.

The ultrasonic sensors 36 are arrayed in three rows in a closest packed arrangement. The sound absorbing member 40 is provided in a form that can cover the vibrating surfaces 37 of all the ultrasonic sensors 36. The sound absorbing member 40 further includes the opening portions 41 at locations corresponding to the vibrating surfaces 37. The opening portions 41 are provided in a rectangular shape respectively in the ranges overlapping the vibrating surfaces 37. In this case, an ultrasonic wave that is output from the transmission unit 10 enters only the areas (effective regions) in the vibrating surfaces 37 overlapped by the opening portions 41. FIG. 20 indicates the effective regions with dots.

Specifically, the opening portions 41 of the sound absorbing member 40 are arranged such that the width w in the scanning direction and the length l in the conveying direction A of the effective region of the vibrating surfaces 37 are kept constant. Furthermore, the opening portions 41 of the sound absorbing member 40 are arranged such that no non-sensing area is present between the scanning areas of the ultrasonic sensors 36. Also, the opening portions 41 of the sound absorbing member 40 are arranged such that the scanning areas of the effective regions in the vibrating surfaces 37 do not mutually overlap in the scanning direction. Specifically, the effective regions in the vibrating surfaces 37 of the ultrasonic sensors 36 arrayed in three rows in the conveying direction A scan mutually different areas, shown as scanning areas w1, w2 and w3 in FIG. 20.

By providing a plurality of ultrasonic sensors 36 and a plurality of opening portions 41 of the sound absorbing member 40 as described above, the foreign material detecting device 135 can improve resolution in the conveying direction A of the receiving unit 30 (ultrasonic line sensor). Also, it is possible to keep the effective region in the vibrating surface 37 from being elongated in the conveying direction A.

Furthermore, by adjusting the interval in the conveying direction A between the positions where the opening portions 41 are provided to be short, it is possible to prevent the detection positions of the ultrasonic sensors 36 from being far away from each other in the conveying direction A.

As a result, it is possible to provide an ultrasonic line sensor capable of detecting an ultrasonic wave with a higher degree of accuracy and a sheet handling apparatus including such an ultrasonic line sensor.

Note that the foregoing embodiments are described as a configuration in which the foreign material detecting device 135 detects foreign material 8 that adheres to the sheet 7, but there is no limitation to such a configuration. The foreign material detecting device 135 can similarly detect stacked sheets (double-fed sheets) by adjusting the comparison reference value of the setting circuit 35.

Also in the description of the foregoing embodiments, when a line sensor is configured by arraying a plurality of ultrasonic sensors 36, the sound absorbing member(s) 40 is(are) arranged such that the scanning areas of the ultrasonic sensors 36 do not mutually overlap in the conveying direction A or the scanning direction. However, there is no limitation to such a configuration. The scanning areas of the ultrasonic sensors 36 may mutually overlap so long as the detection results of the ultrasonic sensors 36 are not affected.

While certain embodiments have been described, those embodiments have been presented by way of example only, and are not intended to limit the scope of the inventions. Indeed, the novel methods and apparatuses described herein may be embodied in a variety of other forms; furthermore, various omissions, substitutions and changes in the form of the methods and apparatuses described herein may be made without departing from the spirit of the inventions. The accompanying claims and their equivalents are intended to cover such forms or modifications as would fall within the scope and spirit of the inventions.

What is claimed is:

1. An ultrasonic line sensor comprising:
a plurality of ultrasonic sensors each comprising a circular vibrating surface and generating an electrical signal in accordance with an ultrasonic wave that enters the vibrating surface; and
at least one sound absorbing member that is provided between the vibrating surfaces of the ultrasonic sensors and a detection target, and that absorbs an ultrasonic wave, the sound absorbing member being arranged in a position where the sound absorbing member overlaps both edge portions of the vibrating surfaces in a scanning direction that is perpendicular to a conveying direction of the detection target, such that effective regions, which are regions in the vibrating surfaces not overlapped by the sound absorbing member, each have two sides parallel to the conveying direction of the detection target.

2. The ultrasonic line sensor according to claim 1, wherein the sound absorbing member is provided such that the effective regions in the vibrating surfaces not overlapped by the sound absorbing member are rectangular.

3. The ultrasonic line sensor according to claim 1, wherein the sound absorbing member is provided such that scanning areas of the effective regions in the vibrating surfaces are continuous in the scanning direction.

4. The ultrasonic line sensor according to claim 1, wherein the sound absorbing member is provided such that the scanning area of the effective region in a vibrating surface does not overlap the scanning area of the effective region in any other vibrating surface.

5. A sheet handling apparatus, comprising:
a conveying unit adapted to convey a sheet;
a receiving unit comprising:
a plurality of ultrasonic sensors each comprising a circular first vibrating surface and generating an electrical signal in accordance with an ultrasonic wave that enters the first vibrating surface; and
at least one first sound absorbing member that is provided between the first vibrating surfaces of the ultrasonic sensors and the conveying unit and that absorbs the ultrasonic wave, the receiving unit receiving an ultrasonic wave that transmits through the sheet;
a transmission unit comprising a second vibrating surface that is provided in a position opposing the receiving unit with the conveying unit placed between the transmission unit and the receiving unit, the transmission unit irradiating the ultrasonic wave onto the sheet conveyed by the conveying unit, by vibrating the second vibrating surface;
a determining unit that compares a detection signal detected by the plurality of ultrasonic sensors of the receiving unit with a reference value stored in advance, and determines whether foreign material adheres to the sheet based on the comparison result; and
a sorting processing unit that sorts the sheets based on the result of determination by the determining unit,
wherein the first sound absorbing member is arranged in a position where the first sound absorbing member overlaps both edge portions of the first vibrating surfaces in a scanning direction that is perpendicular to a conveying direction of the sheet, such that effective regions, which are regions in the first vibrating surfaces not overlapped by the first sound absorbing member, each have two sides parallel to the conveying direction of the sheet.

6. The apparatus according to claim 5, wherein the first sound absorbing member is provided such that the effective regions in the first vibrating surfaces not overlapped by the first sound absorbing member are rectangular.

7. The apparatus according to claim 5, wherein the first sound absorbing member is provided such that scanning areas of the effective regions in the first vibrating surfaces are continuous in the scanning direction.

8. The apparatus according to claim 5, wherein the first sound absorbing member is provided such that the scanning area of the effective region in a first vibrating surface does not overlap the scanning area of the effective region in any other first vibrating surface.

9. The apparatus according to claim 5, wherein in the transmission unit, a second sound absorbing member is provided in the second vibrating surface to limit an output range of the ultrasonic wave irradiated onto the sheet.

10. The apparatus according to claim 9, wherein the second sound absorbing member is formed of a material that absorbs a wave.
